(19) United States
(12) Patent Application Publication
(10) Pub. No.: US 2002/0080199 A1
(43) Pub. Date: Jun. 27, 2002

(54) Electronic mail messages and their use to further business interests of a system director

(75) Inventor: Sheldon Breiner, Portola Valley, CA (US)

Correspondence Address: Stephen M. De Klerk, BLAKELY, SOKOLOFF, TAYLOR & ZAFMAN LLP, Seventh Floor, 12400 Wilshire Boulevard, Los Angeles, CA, 90025-1026, US

(73) Assignee: Wireless Note Systems, Inc.

(21) Appl. No.: 10/091,922

(22) Filed: Mar. 5, 2002

Related U.S. Application Data
(62) Division of application No. 09/565,162, filed on May 3, 2000.

(51) Int. Cl. G09G 5/00

(52) U.S. Cl. 345/864

(57) ABSTRACT

The invention is a notepad incorporating a device for transmitting handwritten notes via email. As part of the system, certain hardware and software are built in the notepad to cause emailed notes to be routed through a server thus building up a userbase. Several specific, automated actions are taken on the note which is beneficial to the sender, the manufacturer, and vendors.

### BACKGROUND OF THE INVENTION

1). Field of the Invention

This invention relates to a kit for recording and transmitting a note created in freehand and the use of this kit in establishing an email userbase for the purpose of delivering commercial services to this userbase.

2). Discussion of Related Art

People often record notes on pieces of paper for their own memory, for filing, or for providing to others. In certain instances it may also be useful to have an electronic copy of such a note for subsequent access to the content of the note. An electronic copy of a note thus created in freehand can also be transmitted by electronic mail. The specification of U.S. patent application Ser. No. 09/321,466 describes a kit which can be used for recording and transmitting an image of a note created in freehand on a notesheet. This specification provides details of how software in the kits, and in the software and server controlling the processing of electronic notes, referred to here as a system director, can utilize the sale of such properly enabled kits to channel their use in furthering multiple business objectives of the system director.

### SUMMARY OF THE INVENTION

A system director is used, among other things, to control the routing and processing of electronic mail and Internet communications. The system director measures the magnitude of traffic of electronic mail messages both handwritten and text, passing through a server; it routs mail to the proper destinations; it invokes special system-director-resident applications when a note is encoded for these applications; it inserts advertisements from certified vendors; and it stores and allows access for certified plug-in applications by third party developers; and it routs notes to manufacturers and distributors of kits and products in support of kits for delivery to users.

Traffic of electronic mail messages passing through the server is initiated by sale of kits for transmission of notes created in freehand. Each kit includes a pad, a detector, a transmitter, and a computer readable medium. The pad has a surface for locating a notesheet on. The detector detects how a note, created in freehand by a writing instrument on the notesheet, is formed, and generates a signal having information of what the note in freehand looks like. The transmitter is in communication with the detector so as to receive the signal. The transmitter transmits the signal to a computer at a remote location. The computer readable medium is insertable into and removable from the computer. The computer readable medium has a program stored thereon. The program is readable by a processor of a computer and includes a receiving module which controls a port of the computer so that the signal is received at the remote location through the port of the computer. The program also has a transmission module which transmits an electronic mail message including at least information of the signal to a recipient. The transmission module includes a routing submodule having information of a predetermined server through which the electronic mail message is transmitted from the computer to the recipient. Because the server is a predetermined server, the system director ensures that all electronic mail message traffic generated utilizing the kit go through the predetermined server so as to generate traffic through the predetermined server. Further traffic is also created using a viral marketing technique whereby a recipient of such emailed notes is not only intrigued by receipt of such, he/she can receive his/her own device and associated paper interface merely by clicking on a logo-actuated link taking them to the server and its system director. The system director routs this request to a billing system and then to a manufacturer or to a retailer of such subsystems who automatically ships the item to the recipient.

### BRIEF DESCRIPTION OF THE DRAWINGS

The invention is further described by way of example with reference to the accompanying drawings wherein:

FIG. 1 is a block diagram illustrating major components of a system which is set up by a system director;

FIG. 2 is a flow chart illustrating how the system director sets up the system of FIG. 1; and

FIG. 3 is a flow chart illustrating how the system director utilizes the system of FIG. 1 to attract potential advertisers.

### DETAILED DESCRIPTION OF THE INVENTION

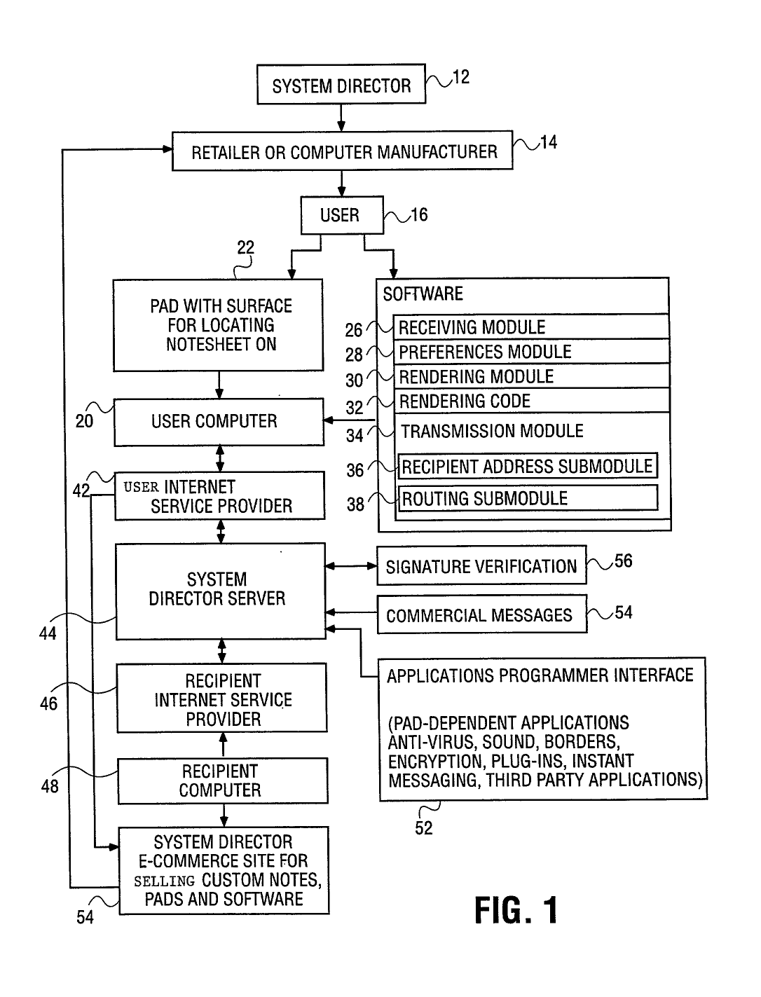

The invention is firstly described by way of example with reference to FIG. 1 which illustrates major components which are set up by a system director. The system utilizes a pad on which a notesheet is located and software which is loaded in memory in a computer. A person can create a note in freehand on a notesheet and transmit a signal including information of what the note in freehand looks to the computer. The software has a transmission module which is preprogrammed by the system director so that an electronic mail message of what the note in freehand looks like is transmitted through a system director server. The system director can thereby control all electronic mail messages being transmitted.

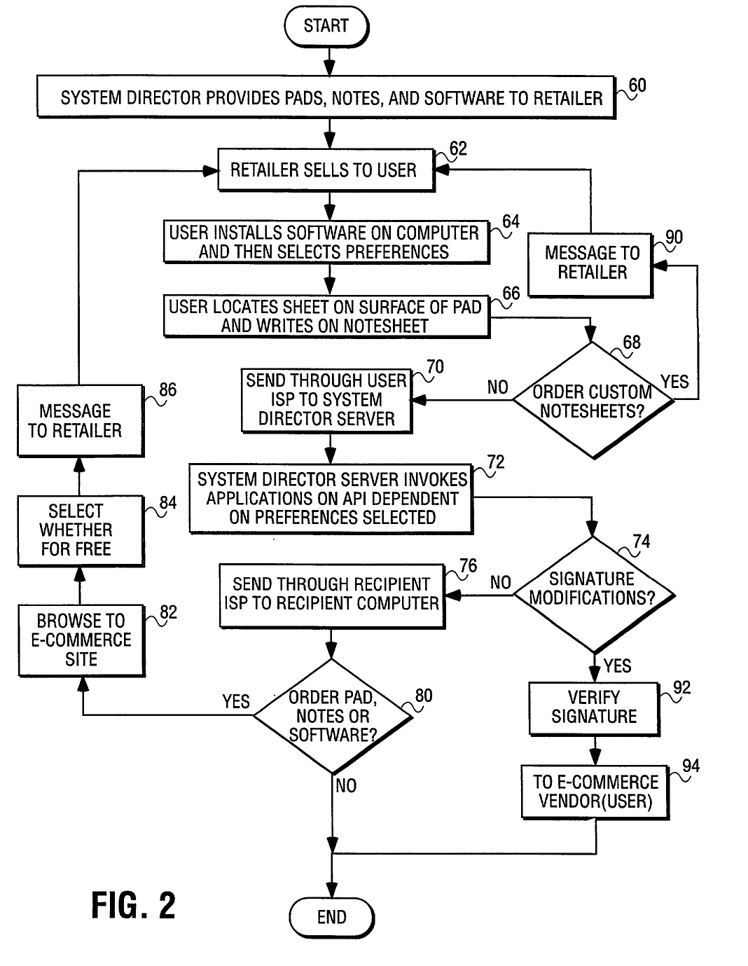

The invention is thereafter further described with reference to FIG. 2 which illustrates how the system is set up by the system director. The system is initially “primed” by the system director who sells pads, notes and software and then continues to sell pads, notes and software to generate electronic mail messages passing through a predetermined system director server. The system then utilizes a viral marketing technique which ensures further sales and growth. Such growth ensures even further electronic mail traffic through the system director server.

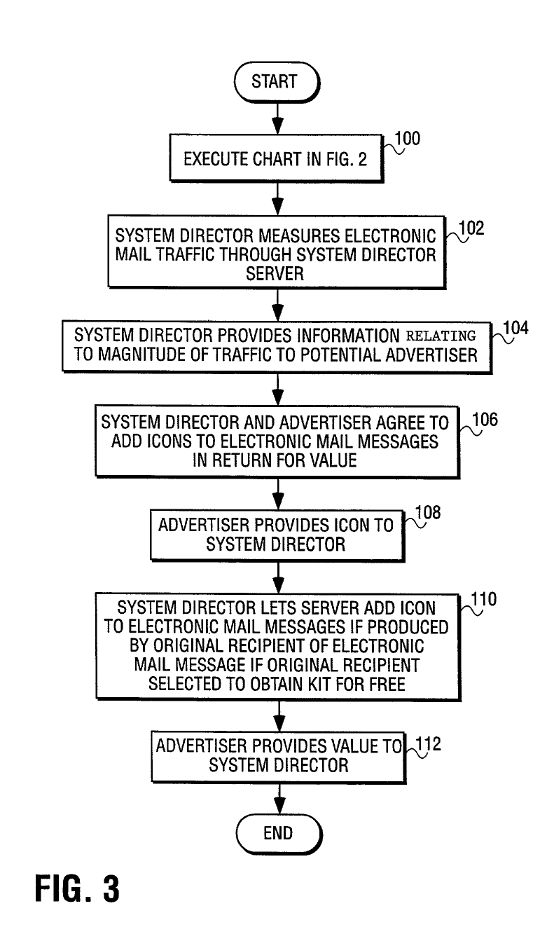

The invention is then further described with reference to FIG. 3 which illustrates how the system director utilizes the electronic mail traffic to attract advertisers and how the advertisers utilize the electronic mail traffic.

Referring now to FIG. 1, a system 10 is illustrated. A system director 12 is in possession of a kit for recording notes in freehand. The kit includes a pad, software, and notesheets as described in U.S. patent application Ser. No. 09/321,466 which is incorporated herein by reference. Suffice to say that the kit includes a pad, a detector, a transmitter, and a computer readable medium. The pad has a surface for locating a notesheet on. The detector detects how a note, created in freehand by a writing instrument on the notesheet, is formed, and generates a signal having information of what the note in freehand looks like. The transmitter is in communication with the detector so as to receive the signal. The transmitter transmits the signal to a computer at a remote location. The computer readable medium is insertable into and removable from the computer. The computer readable medium has a program stored thereon. The program is readable by a processor of a computer and includes a receiving module which controls a port of the computer so that the signal is received at the remote location through the port of the computer. The program also has a transmission module which transmits an electronic mail message including at least information of the signal to a recipient.

The system director 12 provides the kit to a retailer or a computer manufacturer 14. The retailer or computer manufacturer 14 (hereinafter referred to as “retailer”) then sells the kit to a user 16 or users. The user 16 is then in position of the software 18 provided on disk which is insertable into and removable from a computer 20 and installed on a computer 20 of the user. The user 16 is also in possession of the pad 22 which is in communication with the computer 20. The user 16 can then locate a notesheet on the pad 22 and create a note in freehand on the notesheet. A detector detects movement of a writing instrument creating the note in freehand and a transmitter transmits a signal to the computer 20 of what the note in freehand looks like.

The software 18 includes a receiving module 26, a preferences module 28, a rendering module 30, rendering code 32, and a transmission module 34. The receiving module 30 is used to control the computer 20 so that a signal can be received from the pad 22 through a port of the computer 20 into the computer 20. Certain preferences such as sound, borders, and encryption can be selected utilizing the preferences module 28. The rendering module 30 is used to create an image of what the note in freehand looks like on a screen of the computer 20. The rendering code 32 can be transmitted from the computer 20 to a computer of a recipient so that an image of the note in freehand can be created on a screen of a computer of the recipient. The transmission module 34 includes a recipient address submodule 36 and a routing submodule 38. The recipient address submodule includes a list of Internet addresses. The user 16 can select one of the addresses on the notesheet on the pad 22 for purposes of sending an electronic mail message including an image of the note in freehand to a selected recipient.

The routing submodule is set up by the system director 12 before sale of the software 18. The routing submodule 38 ensures that the electronic mail message is transmitted from the user computer 20 through a user Internet service provider (ISP) 42 over the Internet to a pre-selected system director server 44. The electronic mail message is then forwarded by the system director server 44 through a recipient ISP 46 to a recipient computer 48. The system director 12 thereby ensures that all electronic mail messages transmitted utilizing the pad 22 and software 18 go through the system director server 44. The sale of kits including a pad 22 and software 18 therefore increases traffic of Internet mail messages through the system director server 44. The system director 12 thus “primes” traffic through the system director server 44 through initial sale of software 18 and pads 22.

An applications programmer interface (API) 52 is resident on the system director server 44. Pad dependent applications, anti-virus applications, sound, borders, encryption, plug-ins, instant messages, and third party applications may be stored on the API 52. An electronic mail message passing through the system director server 44 may be enhanced with the applications on the API 52. In particular, sound or borders may be added to the electronic mail message or the electronic mail message may be encrypted depending on the preferences selected by the user 16 utilizing the preferences module 28.

As mentioned earlier, the rendering code 32 is transmitted to the recipient computer 48 so that an image of the note in freehand is created on the recipient computer 48 utilizing the rendering code 32. The rendering code 32 also places a link next to the image which, when clicked on by the recipient, opens and directs a browser to a system director e-commerce site 54 for selling custom notes, pads, and software. The recipient can order such notes, pads, and software on the system director e-commerce site 54, whereafter a message is sent to the retailer 14. The software 18 thereby stimulates further sale of notes, pads, and software in a viral marketing technique.

The system 10 also includes signature verification 56 and commercial messages 58. The signature verification 56 will be described hereinbelow with reference to FIG. 2 and the commercial messages 58 will be described hereinbelow with reference to FIG. 3.

FIG. 2 now illustrates further details of how the system director sets the system 10 up. In step 60 the system director provides kits, each kit including a pad, notes, and software, to a retailer. In step 62 the retailer sells the kit to a user. In step 64 the user installs the software on a computer of the user and then selects preferences. In step 66 the user locates a notesheet on the surface of the pad and writes on the notesheet. In step 68 the user can select to order custom notesheets by writing on the notesheet on the pad. If notesheets are not ordered by the user, step 70 is commenced wherein an electronic mail message is sent through a user ISP to the system director server. In step 72 the system director server invokes applications which are resident on the API. The applications are invoked dependent on the preferences selected by the user in step 64. One of the preferences that can be selected by the user is signature verification. In step 74 a determination is made whether the user selected signature verification. If signature verification is not selected then step 76 is commenced wherein the electronic mail message is sent through a recipient ISP to a recipient computer. The electronic mail message is opened on a screen of the recipient computer, including an image of a note created in step 66 as modified in step 72.

It can thus be seen that, as step 62 is repeated, more Internet mail messages will be sent through the system director server in step 70. Steps 60 and 62 can thus be referred to as the “priming” of electronic mail message passing through the system director server in step 70.

In addition, there is also a viral marketing technique carried out in steps 80 to 86. In step 80 the recipient of the electronic mail message can click on a link on the opened message on the screen of the recipient computer to order a pad, notes, or software. If the recipient does click on the link, step 82 is commenced. In step 82 a browser of the recipient is opened and directed to an e-commerce site which provides information of how a kit can be acquired including a pad, notes, or software. In particular, the e-commerce site provides the recipient the option to either order a kit for a fee or to acquire a kit for free. In step 84 the recipient selects whether he wants to acquire the kit for free or for a fee. The relevance of the selection in step 84 will be described with reference to FIG. 3. In step 86 a message is sent to the retailer to order one of the kits. Step 62 is then repeated with the user being substituted with the recipient. It can thus be seen that steps 62 to 86 requires no further input from the system director. Further sales of kits thus has a viral marketing nature wherein it feeds on itself. Such a viral marketing technique further increases the traffic of electronic mail messages passing through the system director server in step 70. The purpose of the increased traffic will be described hereinbelow with reference to FIG. 3.

As mentioned, the user has the option in step 68 to order custom notesheets. If the user does order custom notesheets then step 90 is initiated. In step 90 the message is sent to the retailer including information provided by the user of what the custom notesheets should look like. The retailer then sells the notesheets to the user.

As also mentioned, the user also has the option to select signature verification in step 74. If such a selection is made, then step 92 is commenced. In step 92 details of a signature created in step 66 is sent to a signature verification authority which verifies the authenticity of the signature. The signature verification authority then returns a message to the system director server which in turn sends a message to an e-commerce vendor in step 94. The e-commerce vendor can then determine whether a sale should be made to the user.

The options provided in steps 68 and 74 are examples of facilities that can be provided to a user to further increase traffic through the system director server. The purpose of increasing traffic through the system director server, in particular electronic mail traffic, is now described with reference to FIG. 3.

In step 100 the system director initiates the chart in FIG. 2 which creates electronic mail traffic through the system director server. After some time the system director executes step 102 wherein the system director measures the electronic mail traffic passing through the system director server. In step 104 the system director provides information relating to the magnitude of traffic to a potential advertiser. The purpose of step 104 is to attract the potential advertiser to utilize the system director server for purposes of advertisement in return for value accruing to the system director. In step 106 the system director and advertiser agree to add icons to electronic mail messages passing through the system director server in return for value. The advertiser is interested in adding the icons to the electronic mail messages because of the magnitude of traffic of electronic mail messages passing through the server and because the icons are advertisements for the advertiser.

In step 108 the advertiser provides an icon to the system director. In step 110 the system director programs the system director server so that the icon is added to selected ones of electronic mail messages passing through the system director server. An icon is only added to an electronic mail message if the electronic mail messages originate from an original recipient who selected in step 84 of FIG. 2 to receive a kit for free. An icon is not added to an electronic mail message originating from a user who paid for a kit. Once opened on a screen of a computer of a recipient, the icon may for example be located in a corner of the electronic mail message and may be a link to a website of the advertiser.

In step 110 the advertiser provides value to the system director. The value may take on any form such as the payment of a fee for every icon added to every electronic mail message. It can thus be seen that the system director obtains value from an advertiser because of the magnitude of traffic of electronic mail messages passing through the system director server. The magnitude of traffic depends on both “priming” and viral marketing techniques. The traffic is however ensured because of the sale of the software 18 in FIG. 1 including the routing submodule 38, as used in combination with the pad 22.

While certain exemplary embodiments have been described and shown in the accompanying drawings, it is to be understood that such embodiments are merely illustrative and not restrictive of the current invention, and that this invention is not restricted to the specific constructions and arrangements shown and described since modifications may occur to those ordinarily skilled in the art.

What is claimed:

1. A kit for transmission of a note created in freehand, comprising:
a pad having a surface for locating a notesheet on;
a detector which detects how a note, created in freehand by a writing instrument on the notesheet, is formed, and creating a signal having information of what the note in freehand looks like;
a transmitter in communication with the detector so as to receive the signal, the transmitter transmitting the signal to a computer at a remote location; and
a computer readable medium which is insertable into and removable from the computer, the computer readable medium having a program stored thereon, the program being readable by a processor of the computer and including a receiving module which controls a port of the computer so that the signal is received at the remote location through the port of the computer, and a transmission module which transmits a message including at least information of the signal to a recipient, the transmission module including a routing submodule having information of a predetermined server through which the message is transmitted from the computer to the recipient.

2. The kit of claim 1 wherein the program includes a preferences module which allows a user to select a variable, information of which is transmitted with the message.

3. The kit of claim 2 wherein the variable includes at least one of a border, sound, and encryption.

4. The kit of claim 1 wherein the program includes rendering code which is transmitted with the message and executable by a computer of the recipient to create a recipient note on a screen of the computer of the recipient, the recipient note substantially corresponding with the note in freehand.

5. The kit of claim 4 wherein the program includes a preferences module which allows a user to select a variable, information of which is transmitted with the message.

6. The kit of claim 5 wherein the variable includes at least one of a border for the recipient note, and sound.

7. A method comprising:
measuring a magnitude of traffic of electronic mail messages passing through a server;
providing information of the magnitude of traffic to a potential advertiser;
offering to attach an advertisement from the potential advertiser to at least some of the electronic mail messages passing through the server in exchange for value;
receiving the valve in response to the offering; and
attaching an advertisement from the potential advertiser to at least some of the electronic mail messages passing through the server in exchange for the value.

8. The method of claim 7 further comprising:
providing software to a user, the software being provided to the user comprising a program which is readable by a processor of a computer of the user to transmit information of an electronic mail message, the electronic mail message being directed through the server, whereafter the amount of traffic is measured.

9. The method of claim 8 wherein the software controls the computer so that a signal is received through a port thereof, the information being transmitted including information of the signal.

10. The method of claim 9 further comprising:
providing a pad to the user, the pad having a surface for locating a notesheet on so that the user can create a note in freehand on the notesheet, a signal being transmitted including information of what the note in freehand looks like, the signal being transmitted being the signal received through the port.

11. A method comprising:
providing a kit for transmission of a note in freehand to a user, the kit comprising:
a pad having a surface for locating a notesheet on;
a detector which detects how a note, created in freehand by a writing instrument on the notesheet, is formed, and creating a signal having information of what the note in freehand looks like;
a transmitter in communication with the detector so as to receive the signal, the transmitter transmitting the signal to a computer at a remote location; and
a computer readable medium which is insertable into and removable from the computer, the computer readable medium having a program stored thereon, the program being readable by a processor of the computer and including a receiving module which controls a port of the computer so that the signal is received at the remote location through the port of the computer, and a transmission module which transmits a message including at least information of the signal to a recipient, the transmission module including a routing submodule having information of a predetermined server through which the message is transmitted from the computer to the recipient.

12. The method of claim 11, further comprising:
measuring a magnitude of traffic of electronic mail messages passing through the predetermined server;
providing information of the magnitude of traffic to a potential advertiser;
offering to attach an advertisement from the potential advertiser to at least some of the electronic mail passing messages through the server in exchange for valve;
receiving the vale in response to the offering; and
attaching an advertisement from the potential advertiser to at least some of the electronic mail messages passing through the server in exchange for the valve.

13. The method of claim 11 further comprising:
attaching a link to the message, the link directing a browser to a website which includes information of the kit.

14. The method of claim 13 wherein the website includes an offer for sale of the kit.

15. The method of claim 13, further comprising: measuring a magnitude of traffic of electronic mail messages passing through a server;
providing information of the magnitude of traffic to a potential advertiser;
offering to attach an advertisement from the potential advertiser to at least some of the electronic mail passing messages through the server in exchange for valve;
receiving the valve in response to the offering; and
attaching an advertisement from the potential advertiser to at least some of the electronic mail messages passing through the server in exchange for the valve.

16. The method of claim 15 wherein the website includes an offer for the kit at a normal price and for a reduced price, the recipient selecting either the normal price or the reduced price and the advertisement being attached if the reduced price is selected and not when the normal price is selected.

17. The method of claim 11 wherein the program includes a preference module for selection of a preference, the server executing a function based on the preference selected.

18. The method of claim 17 wherein the function is at least one of the creation of a border, the addition of sound, encryption, and virus cleanup.

19. A computer readable medium having a program stored thereon, the program being readable by a processor of a computer to execute the method comprising:
transmitting a message to an Internet service provider (ISP);
transmitting the message from the ISP to a predesignated system director server (SDS); and
transmitting the message from the SDS to a recipient selected by a user of the computer.

20. The compute readable medium of claim 19 wherein the method further comprises receiving a signal through a port of the computer, the signal including information of a note created in freehand, the message being sent tot the ISP, SDS and recipient including the information of the note created in freehand.
